(19) United States
(12) Patent Application Publication
(10) Pub. No.: US 2025/0309232 A1
(43) Pub. Date: Oct. 2, 2025

(54) METHOD FOR RECOVERING PERFORMANCE OF POSITIVE ELECTRODE FOR LITHIUM-ION SECONDARY BATTERY

(71) Applicant: HONDA MOTOR CO., LTD., Tokyo (JP)

(72) Inventors: Shuichi Kazuno, Wako-shi (JP); Tomohiro Inoue, Wako-shi (JP); Sae Ishihara, Wako-shi (JP); Takashi Higono, Wako-shi (JP); Taichiro Sato, Wako-shi (JP); Takeshi Muro, Wako-shi (JP); Kenta Urata, Wako-shi (JP)

(21) Appl. No.: 19/066,309

(22) Filed: Feb. 28, 2025

(30) Foreign Application Priority Data
Mar. 29, 2024 (JP) 2024-057912

(51) Int. Cl. H01M 4/04; H01M 4/02; H01M 10/0525

(52) U.S. Cl. CPC H01M 4/0459; H01M 4/0445; H01M 10/0525; H01M 2004/028

(57) ABSTRACT

A method for recovering performance of a positive electrode for a lithium-ion secondary battery by doping lithium ions into the positive electrode for a lithium-ion secondary battery having a decreased capacity, in which the doping of the lithium ion is performed in an electrolytic solution by a discharge using a lithium electrode as a counter electrode, and the discharge is performed within a range of a predetermined accumulated discharge amount DG [Ah].

### CROSS-REFERENCE TO RELATED APPLICATION

Priority is claimed on Japanese Patent Application No. 2024-057912, filed Mar. 29, 2024, the content of which is incorporated herein by reference.

### BACKGROUND OF THE INVENTION

### Field of the Invention

The present invention relates to a method for recovering the performance of a positive electrode for a lithium-ion secondary battery.

### Description of Related Art

Recently, from the viewpoint of climate-related disasters, an interest in electric vehicles has been rising for CO₂ reduction, and studies on the use of lithium-ion secondary batteries for automotive applications have been in progress.

Usually, the performance of a lithium-ion secondary battery deteriorates as the lithium-ion battery is repeatedly charged and discharged. Various proposals have been made regarding a method for recovering the performance of a lithium-ion secondary battery.

For example, PCT International Publication No. WO 2022/034717 discloses a device for recovering the capacity of a secondary battery including a capacity estimation portion that calculates an estimated capacity, which is an estimated value of the capacity of the secondary battery, a capacity recovery process portion that performs a capacity recovery process of the secondary battery by migrating reaction species from a capacity recovery electrode to a positive electrode or a negative electrode, and an electricity quantity calculation portion that calculates the quantity of electricity conducted, which is a quantity of electricity that is supposed to be conducted to the capacity recovery electrode, in which the capacity recovery process portion includes an electricity quantity monitoring portion that determines the quantity of electricity flowing to the positive electrode or the negative electrode from the capacity recovery electrode or a voltage monitoring portion that monitors the voltage between the capacity recovery electrode and the positive electrode or the negative electrode.

Japanese Unexamined Patent Application, First Publication No. 2012-022969 discloses a method for regenerating an electrode of a lithium-ion secondary battery in which an electrode of a used lithium-ion secondary battery is washed with a polar solvent to wash away a Li-containing degradation substance adhering to the surfaces of active material particles, which is a main factor for the capacity degradation of the electrode, the electrode is sufficiently dried to volatilize the washing solvent, and an electrolytic solution is reinjected into the battery with the dried electrode.

Japanese Unexamined Patent Application, First Publication No. 2002-324585 discloses a non-aqueous electrolyte secondary battery including a positive electrode, a negative electrode other than metallic lithium, and a non-aqueous electrolyte, in which a third electrode that contains metallic lithium, is not in contact with any electrolytic solutions, and is not connected to the positive electrode and the negative electrode is provided.

### SUMMARY OF THE INVENTION

None of Patent Documents 1 to 3 disclose means for appropriately controlling the degree of recovery.

An aspect of the present invention has been made in consideration of what has been described above, and an object of the present invention is to provide a method for recovering the performance of a positive electrode for a lithium-ion secondary battery, which is capable of achieving the optimal recovery state of the positive electrode for a lithium-ion secondary battery.

The aspect of the present invention proposes the following configurations.

[1] A method for recovering performance of a positive electrode for a lithium-ion secondary battery by doping lithium ions into the positive electrode for a lithium-ion secondary battery having a decreased capacity,
in which the doping of the lithium ion is performed in an electrolytic solution by a discharge using a lithium electrode as a counter electrode, and
the discharge is performed within a range of an accumulated discharge amount DG [Ah] represented by a formula 1 below:

$$0.95 \times DG 0 \leq DG \leq 1.05 \times DG 0 , \qquad Formula 1$$

wherein DG0 is a value that is calculated by a formula 2 below:

$$DB \times [ ( D B - DA ) / DB + X ] , \qquad Formula 2$$

wherein DB [Ah] is a capacity of the lithium-ion secondary battery as a new product, DA [Ah] is a capacity of the lithium-ion secondary battery having a decreased capacity, and X is a correction coefficient selected from X1, X2, and X3 below:
X1: a correction coefficient based on lithium ions consumed to form a film in a formation step of the lithium-ion secondary battery in an initial state,
X2: a correction coefficient based on degradation of a negative electrode in the lithium-ion secondary battery, and
X3: a correction coefficient based on reaction resistance and migration resistance of lithium ions in the lithium-ion secondary battery.

[2] The method according to [1], which is performed non-destructively with respect to the positive electrode.

[3] The method according to [1] or [2], in which the discharge is performed at a constant current.

[4] The method according to any one of [1] to [3], in which the (DB−DA)/DB is 0.7 or more.

[5] The method according to [1], in which the X1 is a numerical value within a range of 0 to 0.25, the X2 is a numerical value within a range of 0 to 0.1, and the X3 is a numerical value within a range of 0 to 0.18.

[6] The method according to any one of [1] to [5], in which the X3 is calculated by a formula 3 below:

$$X 3 = X 3 a + X 3 b + X 3 c + X 3 d , \qquad Formula 3$$

wherein X3a is a correction coefficient based on reaction resistance and migration resistance of lithium ions in the positive electrode upon using the lithium-ion secondary battery after performance recovery and is a numerical value within a range of 0 to 0.05,
X3b is a correction coefficient based on reaction resistance and migration resistance of lithium ions in the negative electrode upon using the lithium-ion secondary battery after performance recovery and is a numerical value within a range of 0 to 0.05,
X3c is a correction coefficient based on migration resistance of lithium ions in the electrolytic solution upon using the lithium-ion secondary battery after performance recovery and is a numerical value within a range of 0 to 0.04, and
X3d is a correction coefficient based on migration resistance of lithium ions in a separator upon using the lithium-ion secondary battery after performance recovery and is a numerical value within a range of 0 to 0.04.

[7] A method for recovering performance of a positive electrode for a lithium-ion secondary battery by doping lithium ions into the positive electrode for a lithium-ion secondary battery having a decreased capacity,
in which the doping of the lithium ions is performed in an electrolytic solution by a discharge using a lithium electrode as a counter electrode,
the doping of the lithium ions is controlled based on an accumulated value of a current upon conduction of electricity, and
an accumulated value of the current upon completion of the conduction of electricity is set based on a difference between a capacity in the initial state of the lithium-ion secondary battery and a capacity of the lithium-ion secondary battery having a decreased capacity and a correction coefficient.

[8] The method according to [7], in which the correction coefficient includes at least one of a first correction coefficient based on the difference between the capacity in the initial state of the lithium-ion secondary battery and the capacity of the lithium-ion secondary battery having a decreased capacity, a second correction coefficient based on an amount of lithium ion consumed in a formation step of the lithium-ion secondary battery, and a third correction coefficient based on a discharge efficiency of the lithium-ion secondary battery.

It is possible to provide a method for recovering the performance of a positive electrode for a lithium-ion secondary battery, which is capable of appropriately recovering the performance of the positive electrode for a lithium-ion secondary battery.

### BRIEF DESCRIPTION OF THE DRAWINGS

FIG. 1 is a view for describing a configuration at the time of performing discharge in one embodiment of a performance recovery method of the present invention.

FIG. 2 is a graph for describing a method for obtaining a capacity deviation component relative to a battery in an initial state (BOL) as an optimal value of a doping amount (Vm: measured full cell capacity, Vcal: estimated full cell capacity, Vp: calculated positive electrode capacity, Vc: measured positive electrode capacity, Vn: calculated negative electrode capacity, and Vn′: measured negative electrode capacity).

FIG. 3 is a graph for describing a relationship between a degree of a SOH decreased of the battery and the capacity deviation due to degradation of a negative electrode.

FIG. 4 is a schematic view for describing the degradation of the negative electrode.

FIG. 5 is a graph showing the relationship between the amount of Li in the negative electrode and the capacity decrease by ICP emission spectroscopy.

FIG. 6 is a schematic view for describing the types of resistance in a battery.

FIG. 7 is a graph showing a change in a capacity of a positive electrode active material due to pressing and washing.

FIG. 8 is a graph showing results of performing pressing and washing and performing a recovery treatment based on an optimal value of a doping amount without consideration of a correction coefficient X.

### DETAILED DESCRIPTION OF THE INVENTION

Hereinbelow, a method for recovering the performance of a positive electrode for a lithium-ion secondary battery according to an embodiment of the present invention is described with reference to drawings.

The method of the present embodiment is a method for recovering performance of a positive electrode for a lithium-ion secondary battery by doping lithium ions into the positive electrode for a lithium-ion secondary battery having a decreased capacity, in which the doping of lithium ions is performed under a predetermined condition to be described below.

In this context, “initial state” means that the lithium-ion secondary battery is in an unused state or the lithium-ion secondary battery is in an undegraded state, that is, a state where the capacity of the lithium-ion secondary battery has not been decreased due to a charge/discharge cycle.

In addition, the method of the present embodiment is preferably performed non-destructively without disassembling the positive electrode into components.

### (Lithium-Ion Secondary Battery)

A lithium-ion secondary battery the performance of which is recovered by the method of the present embodiment (hereinafter, also simply referred to as “battery”) is not particularly limited, and a well-known lithium-ion secondary battery can be used. The lithium-ion secondary battery is usually composed of a positive electrode, a negative electrode, and an electrolyte (an electrolytic solution or a solid electrolyte) that is disposed between the positive electrode and the negative electrode. In addition, a separation membrane (separator) may be provided between the positive electrode and the negative electrode. The positive electrode and the negative electrode each contain an active material, a binder, and a current collector. Hereinbelow, the configurations of the positive electrode and the negative electrode are described.

### “Positive Electrode”

The positive electrode contains a positive electrode active material, a positive electrode conductive agent, a positive electrode binder, and a positive electrode current collector. A layer composed of the positive electrode active material, the positive electrode conductive agent, and the positive electrode binder is regarded as a positive electrode mixture layer. The positive electrode mixture layer may be formed on one surface or both surfaces of the positive electrode current collector. The positive electrode mixture layer may contain no positive electrode conductive agent as long as the positive electrode active material is sufficiently conductive.

The positive electrode active material, which is an active material that is used in the positive electrode, is not particularly limited as long as the positive electrode active material is capable of storing and releasing Li ions. Examples of the positive electrode active material include lithium nickel oxide (for example, LiNiO₂), lithium cobalt oxides (for example. LiCoO₂), lithium nickel cobalt oxide, lithium nickel cobalt manganese oxide, LiFePO₄, LiMn₁₋ₓFeₓPO₄, LiMnPO₄, LiCoPO₄, LiNiPO₄, and the like. The positive electrode active material preferably contains one or more selected from the group consisting of manganese, nickel, and cobalt.

The positive electrode conductive agent, which is a conductive agent that is used in the positive electrode, assists the formation of a conductive path between the positive electrode active material and the positive electrode current collector. The positive electrode conductive agent is not particularly limited as long as the positive electrode conductive agent is conductive, and examples thereof include carbon black such as acetylene black, carbon nanotubes, graphite such as artificial graphite, and the like.

The positive electrode binder, which is a binder for the positive electrode active material, binds together the positive electrode active material, the positive electrode conductive agent, and the positive electrode current collector. Examples of the positive electrode binder include polyvinylidene fluoride (PVDF), polytetrafluoroethylene (PTFE), polyamide (PA), polyimide (PI), polyacrylic acids, copolymers thereof, polyamideimide (PAI), polybenzimidazole, polyethersulfone (PES), maleic anhydride-modified polypropylene, mixtures thereof, and the like. The positive electrode binder preferably contains a crystalline polymer having a melting point. The positive electrode binder is preferably a polymer containing fluorine. Examples of the polymer containing fluorine include PVDF, PTFE, and the like.

Examples of the positive electrode current collector include metal foils such as an aluminum foil, a stainless steel foil, and a nickel foil. The positive electrode current collector may have a carbon coating layer formed thereon. In addition, the positive electrode current collector may be processed into a mesh.

### “Negative Electrode”

The negative electrode contains a negative electrode active material, a negative electrode conductive agent, a negative electrode binder, and a negative electrode current collector. A layer composed of the negative electrode active material, the negative electrode conductive agent, and the negative electrode binder is regarded as a negative electrode mixture layer. The negative electrode mixture layer may be formed on one surface or both surfaces of the negative electrode current collector. The negative electrode mixture layer may contain no negative electrode conductive agent as long as the negative electrode active material is sufficiently conductive.

The negative electrode active material, which is an active material that is used in the negative electrode, is not particularly limited as long as the negative electrode active material is capable of storing and releasing Li ions. Examples of the negative electrode active material include graphite (artificial graphite and natural graphite), amorphous carbon (hard carbon), mesocarbon microbeads, carbon fibers, Si materials (silicon, Si alloys, and Si oxides), and the like.

The negative electrode conductive agent, which is a conductive agent that is used in the negative electrode, assists the formation of a conductive path between the negative electrode active material and the negative electrode current collector. The negative electrode conductive agent is not particularly limited as long as the negative electrode conductive agent is conductive, and examples thereof include carbon black such as acetylene black, carbon nanotubes, graphite such as artificial graphite, and the like.

The negative electrode binder, which is a binder for the negative electrode active material, binds together the negative electrode active material, the negative electrode conductive agent, and the negative electrode current collector. Examples of the negative electrode binder include carboxymethyl cellulose, polyvinylidene fluoride, polytetrafluoroethylene, polyacrylic acid, fluororubber, diene-based rubber such as styrene butadiene rubber, and the like. The negative electrode binder preferably contains a crystalline polymer having a melting point.

Examples of the negative electrode current collector, which is a current collector for the negative electrode, include metal foils such as a copper foil, a stainless steel foil, and a nickel foil. The negative electrode current collector may have a carbon coating layer formed thereon. In addition, the negative electrode current collector may be processed into a mesh shape.

(Step of Doping Lithium Ions into Positive Electrode)

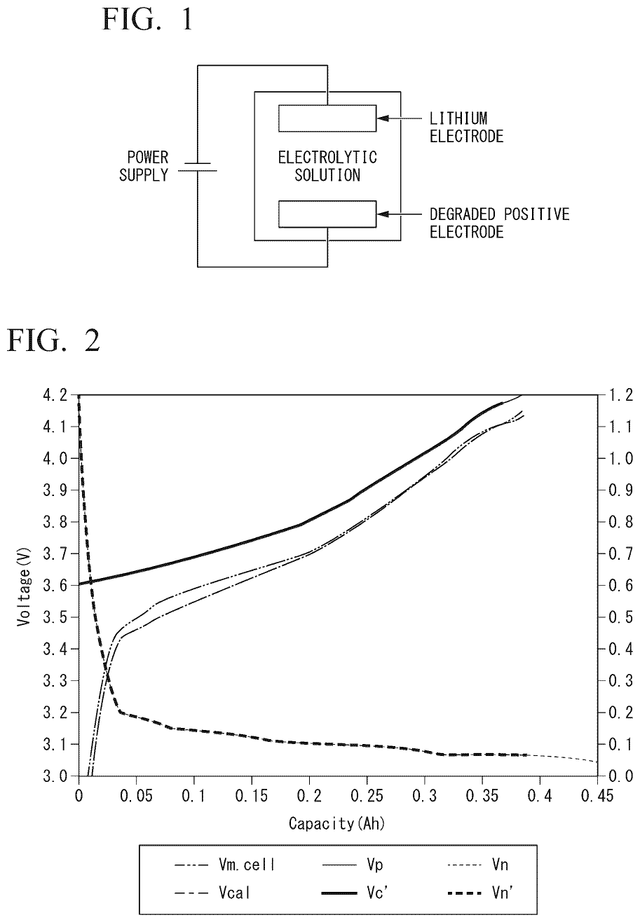

In the method of the present embodiment, the doping of lithium ions is performed in an electrolytic solution by discharge using a lithium electrode as a counter electrode. A configuration for performing the discharge is illustrated in FIG. 1. That is, as illustrated in FIG. 1, the positive electrode and the lithium electrode, as the counter electrode, are immersed in the electrolytic solution, a voltage is applied between the positive electrode and the lithium electrode to perform discharge from the lithium electrode.

The discharge is performed within a range of an accumulated discharge amount DG [Ah] represented by a formula 1 below (hereinafter, this step will also be referred to as “recovery process” in some cases).

$$0.95 \times DG 0 \leq DG \leq 1.05 \times DG 0 \qquad Formula 1$$

In the formula 1, DG0 is a value that is calculated by a formula 2 below:

$$DB \times [ ( D B - DA ) / DB + X ] \qquad Formula 2$$

In the formula 2, DB [Ah] is the capacity of the lithium-ion secondary battery in the initial state, DA [Ah] is the capacity of the lithium-ion secondary battery having a decreased capacity, and X is a correction coefficient selected from X1, X2, and X3 described below.

In the formula 2, DB [Ah] may be considered as the capacity of the positive electrode for a lithium-ion secondary battery in the initial state or DA [Ah] may be considered as the capacity of the positive electrode for a lithium-ion secondary battery having a decreased capacity.

X1, X2, and X3 are as follows:
X1: a correction coefficient based on lithium ions consumed to form a film in a formation step of the lithium-ion secondary battery in the initial state,
X2: a correction coefficient based on degradation of the negative electrode in the lithium-ion secondary battery, and
X3: a correction coefficient based on the reaction resistance and migration resistance of lithium ions in the lithium-ion secondary battery.

The (DB−DA)/DB is preferably 0.7 or more. When the (DB−DA)/DB is 0.7 or more, it is possible to recover the performance of the positive electrode for a lithium-ion secondary battery more reliably by the method of the present embodiment.

In addition, the discharge is preferably performed at a constant current (CC).

### “Counter Electrode”

The lithium electrode as the counter electrode is desirably metallic lithium and can be configured in the same manner as the negative electrode.

### “Electrolytic Solution”

The electrolytic solution is not particularly limited, and solutions that are usually used as electrolytic solutions for lithium-ion secondary batteries can be used. For example, it is possible to apply aprotic organic solvents such as ethylene carbonate (EC), propylene carbonate (PC), butylene carbonate (BC), dimethyl carbonate (DMC), ethyl methyl carbonate (EMC), diethyl carbonate (DEC), methyl propyl carbonate (MPC), and ethyl propyl carbonate (EPC).

In addition, as the electrolytic solution, it is possible to apply electrolytic solutions obtained by dissolving a lithium salt, such as lithium hexafluorophosphate, lithium tetrafluoroborate, lithium perchlorate, lithium iodide, lithium chloride, lithium bromide, LiB[OCOCF₃]₄, LiB[OCOCF₂CF₃]₄, LiPF₄(CF₃)₂, LiN(SO₂CF₃)₂, or LiN(SO₂CF₂CF₃)₂, or a mixture of two or more lithium salts thereof in a solvent mixture of two or more organic compounds out of these aprotic organic solvents.

### “Accumulated Discharge Amount DG [Ah]”

The accumulated discharge amount DG [Ah] satisfies the formula 1 and preferably satisfies a formula 1a below.

$$0.95 \times DG 0 \leq DG \leq 1.05 \times DG 0 \qquad Formula 1$$

$$0.98 \times DG 0 \leq D G \leq 1.02 \times DG 0 \qquad Formula 1 a$$

When the discharge is performed within a range of the accumulated discharge amount DG [Ah] that satisfies the above-described formula, it is possible to prevent the capacity after the recovery process from becoming deficient or excessive compared with the capacity in the initial state. When the capacity is excessively recovered and becomes larger than that in the initial state, the amount of Li in the positive electrode becomes excessive, and in a case where this positive electrode is incorporated into the battery again, there is a concern that a dendrite (also referred to as a dendritic crystal) may be generated due to the deposition of metallic Li. From this viewpoint, the recovery rate that is represented by the proportion (%) (xd/x×100) of the capacity (xd) of the lithium-ion secondary battery after the completion of the doping to the capacity (x) of the lithium-ion secondary battery in the initial state is preferably adjusted to 90% to 110%, more preferably 95% to 105%, and substantially, most preferably 100%. Alternatively, the recovery rate that is represented by the proportion (%) (xd/x×100) of the capacity (xd) of the positive electrode for a lithium-ion secondary battery after the completion of the doping to the capacity (x) of the positive electrode for a lithium-ion secondary battery in the initial state is preferably adjusted to 90% to 110%, more preferably 95% to 105%, and substantially, most preferably 100%.

In conventional methods, even when an attempt is made to recover the capacity by an amount decreased by the use, proper control is not possible, and it is not possible to prevent the capacity after the recovery process from becoming deficient or excessive. But the present invention enables an optimal recovery state to be realized by controlling the discharge based on the accumulated discharge amount DG [Ah] that satisfies the above-described formula.

A method for determining the range of the accumulated discharge amount DG [Ah] is described below.

First, the optimal value of the doping amount by the discharge (a value without consideration of the above-described correction coefficient X) can be determined as described below. For example, a charge and a discharge are performed under the following conditions.
Upper limit value: 3 V discharge (discharge at a constant current (CC) of 0.1 C)
Lower limit value: 4.15 V charge (charge at a constant current of 0.1 C and a constant voltage (CCCV))

The 0.1C (or 0.05C) capacity is measured in a state where a cell is not yet disassembled, fitting analysis is performed on the capacity usage amounts and capacity deviations of the positive electrode and the negative electrode, and the capacity deviation component relative to the cell in the initial state (BOL) is obtained as the optimal value of the doping amount (FIG. 2).

Alternatively, the open circuit voltage (OCV) of the cell upon the 3 V discharge and the open circuit potential (OCP) of the positive electrode after the disassembly of the cell are measured, and the capacity deviation component relative to the cell in the initial state (BOL) is obtained as the optimal value of the doping amount from SOC (state of charge)-OCV and SOC-OCP curves.

For example, in a case where the SOH (state of health) has decreased to 90% from the initial state, when the capacity in the initial state is 8.0 Ah, the optimal value of the doping amount becomes 0.8 Ah from 8.0 Ah×(100%−90%). Therefore, if the correction coefficient X is not taken into account, a discharge is performed from the counter electrode, the discharge amount is accumulated from the beginning of the discharge, and in a case where the accumulated value reaches 0.8 Ah, the discharge is ended.

In a case where the SOH has decreased to 80% from the initial state, when the capacity in the initial state is 8.0 Ah, the optimal value of the doping amount becomes 1.6 Ah from 8.0 Ah×(100%−80%). Therefore, if the correction coefficient X is not taken into account, a discharge is performed from the counter electrode, the discharge amount is accumulated from the beginning of the discharge, and in a case where the accumulated value reaches 1.6 Ah, the discharge is ended.

Controlling the discharge based on the accumulated discharge amount DG [Ah] has several advantages. First, specifically, regardless of the potential, the discharge can be controlled with the attention paid only to the above-described current accumulated value. In addition, as the battery capacity itself is evaluated in Ah, direct control based on current accumulation is possible. Furthermore, the discharge can be controlled only with the current without using any potential sensors.

However, when the discharge is controlled based on the optimal value for which an ideal state is assumed as described above, it is not possible to avoid the capacity after the recovery process becoming deficient or excessive relative to the capacity in the initial state. Therefore, it becomes necessary to take the correction coefficient X into account.

Hereinbelow, each correction coefficient (X1, X2, or X3) is described.

### <X1>

X1 is a correction coefficient based on lithium ions consumed to form a film in a formation step of the lithium-ion secondary battery in the initial state and is preferably a numerical value within a range of 0 to 0.25.

That is, X1 is a correction coefficient in consideration of the influence of formation and is a value that is 1/100 of the proportion (%) of Li that is consumed to form a film by formation. Regarding this value, it is normal that the numerical value of X1 decreases as the number of times of formation increases. The proportion (%) of Li that is consumed to form a film by formation changes, for example, as described below.
1st formation: 20.3%
2nd formation: 1.4%
3rd formation: 0.8%
4th formation: 0.4%

This correction coefficient X1 is obtained from the average value in experimental results as shown in Table 1.

TABLE 1

| | | Sample 1 | Sample 2 |
|---|---|---|---|
| 316 mAh | 3.0 to 4.15 V | | |
| 0.2 C charge | mAh | 443.465 | 441.129 |
| 0.2 C discharge | mAh | 353.455 | 351.357 |
| 0.2 C charge | mAh | 355.807 | 353.592 |
| 0.2 C discharge | mAh | 350.963 | 348.848 |
| 0.2 C charge | mAh | 351.935 | 349.761 |
| 0.2 C discharge | mAh | 349.148 | 347.023 |
| 1st efficiency | % | 79.7 | 79.6 |
| 2nd efficiency | % | 98.6 | 98.7 |
| 3rd efficiency | % | 99.2 | 99.2 |

Note:
The “1st efficiency”, “2nd efficiency” and “3rd efficiency” respectively refer to the proportion (%) of Li not consumed in the film formation in the first formation, the second formation and the third formation.

As this correction coefficient X1, a value measured after the performance recovery process may be used.

### <X2>

X2 is a correction coefficient based on degradation of the negative electrode in the lithium-ion secondary battery and is preferably a numerical value within a range of 0 to 0.1. That is, X2 is a correction coefficient in consideration of the influence of degradation of the negative electrode and is a value that is 1/100 of the capacity deviation (%) due to degradation of the negative electrode.

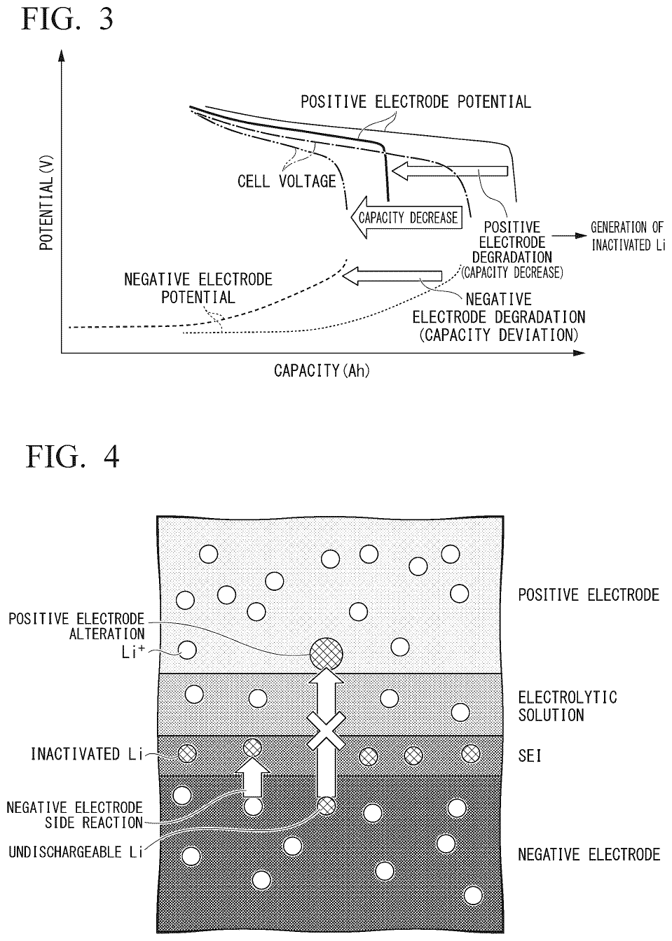

The degree of the SOH decreased of the battery and the capacity deviation (%) due to degradation of the negative electrode have a proportional relationship (FIG. 3). Main causes of the decrease in the SOH are a decrease in the capacity of the positive electrode and the capacity deviation of the negative electrode, but Li is accumulated on the negative electrode side in any case. That is, a decrease in the capacity proceeds due to the inactivation of Li arising from the formation of SEI (solid electrolyte interface) in the negative electrode (FIG. 4).

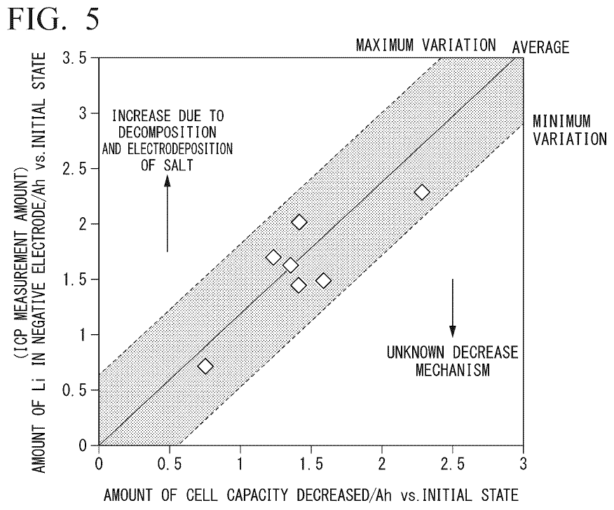

Analysis of the battery by ICP emission spectroscopy makes it possible to confirm the relationship between the amount of Li in the negative electrode and a decrease in the capacity (FIG. 5).

In a case where the correction coefficient X2 is obtained based on the SOH, the correction coefficient can be estimated from the number of times of a charge and a discharge or can be obtained based on a dQ/dV curve.

For example, X2 can be obtained with the capacity deviation of the negative electrode considered as 1.2% (X2=0.012) when the SOH is decreased by 10% by use from the initial state and with the capacity deviation of the negative electrode considered as 2.4% (X2=0.024) when the SOH is decreased by 20%.

### <X3>

X3 is a correction coefficient based on the reaction resistance and migration resistance of lithium ions in the lithium-ion secondary battery and is preferably a numerical value within a range of 0 to 0.18.

More specifically, the X3 is preferably calculated by a formula 3 below.

$$X 3 = X 3 a + X 3 b + X 3 c + X 3 d \qquad Formula 3$$

In the formula 3,
X3a is a correction coefficient based on the reaction resistance and migration resistance of lithium ions in the positive electrode upon using the lithium-ion secondary battery after performance recovery and is a numerical value within a range of 0 to 0.05,
X3b is a correction coefficient based on the reaction resistance and migration resistance of lithium ions in the negative electrode upon using the lithium-ion secondary battery after performance recovery and is a numerical value within a range of 0 to 0.05,
X3c is a correction coefficient based on the migration resistance of lithium ions in the electrolytic solution upon using the lithium-ion secondary battery after performance recovery and is a numerical value within a range of 0 to 0.04, and
X3d is a correction coefficient based on the migration resistance of lithium ions in a separator upon using the lithium-ion secondary battery after performance recovery and is a numerical value within a range of 0 to 0.04.

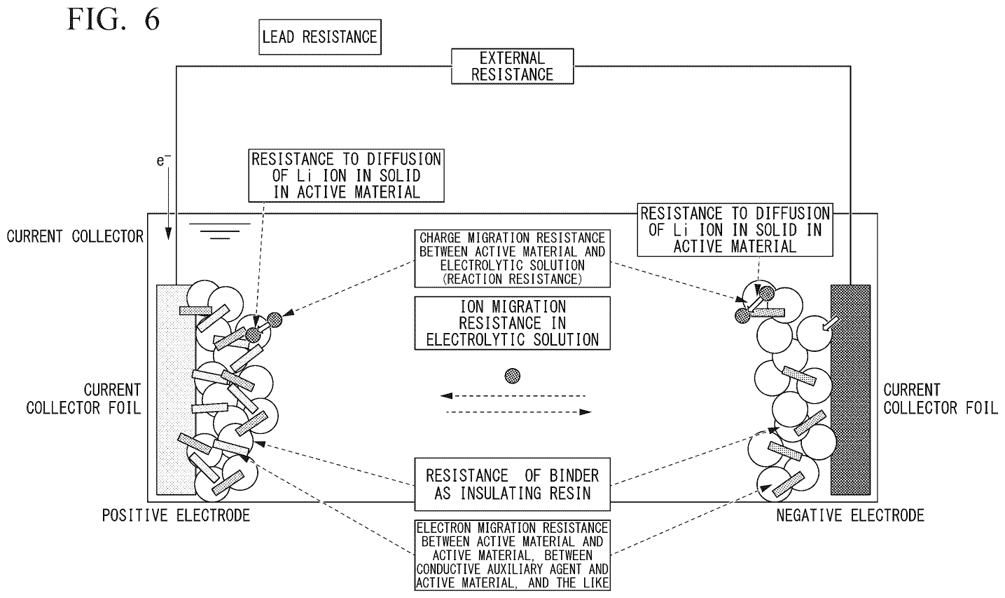

The types of resistance in a battery are shown in FIG. 6.

That is, X3 is a correction coefficient in consideration of resistance in the battery and is a value that is 1/100 of the total (%) of a variety of types of resistance.

Each resistance component can be measured using an alternating current impedance method, a multi-point probe method, or the like.

### <Other Correction Coefficients>

In the case of performing a capacity recovery process other than the doping of lithium ions (hereinafter, also referred to as “other recovery process”), a recovery capacity component attributed to the other recovery process is also preferably taken into account as a correction coefficient XN. In addition, a crystal structure collapse component of the positive electrode that is predicted by impedance measurement is also preferably taken into account as the correction coefficient XN. The correction coefficient XN is preferably 0 to 0.2.

In this case, DG0 in the formula 1 is preferably a value that is calculated by a formula 2a below.

$$DB \times [ ( D B - DA ) / DB + X - XN ] \qquad Formula 2 a$$

As the other recovery processes, pressing, washing, film removal and the like can be performed. For example, in a case where capacity components that are recovered by pressing, washing, and film removal are 1%, 6%, and 1%, the recovery capacity component attributed to the other recovery processes is 8%, and a value of 0.08, which is 1/100 of the recovery capacity component, is regarded as the correction coefficient XN.

The pressing is performed by compressing the positive electrode in the thickness direction. The compression can be performed by a well-known method, such as roll pressing.

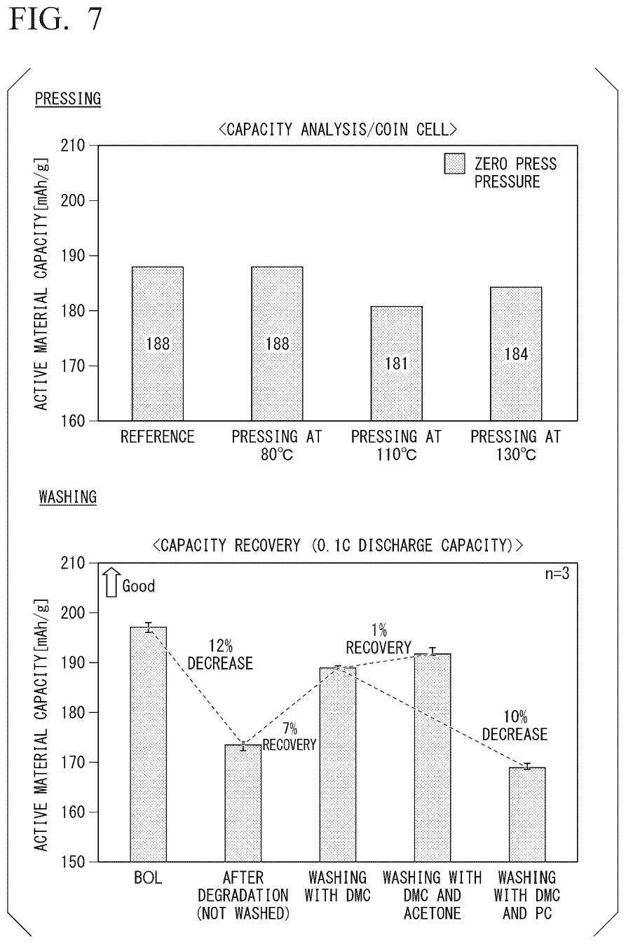

As a result of observing a change in the capacity of the positive electrode active material in the case of performing pressing at 80° C., 110° C., and 130° C., the results as shown in FIG. 7 are obtained.

In addition, regarding the washing as well, a well-known method can be employed. For example, the positive electrode is preferably washed using a solvent such as dimethyl carbonate (DMC), acetone, or propylene carbonate (PC).

Regarding the film removal as well, a well-known method can be employed.

Regarding a battery having a capacity decreased by 12% by use from the initial state (BOL), the positive electrode is washed with dimethyl carbonate (DMC), acetone, and propylene carbonate (PC), and consequently, the results as shown in FIG. 7 are obtained. In this context, in the case of the DMC line, XN becomes 0.07.

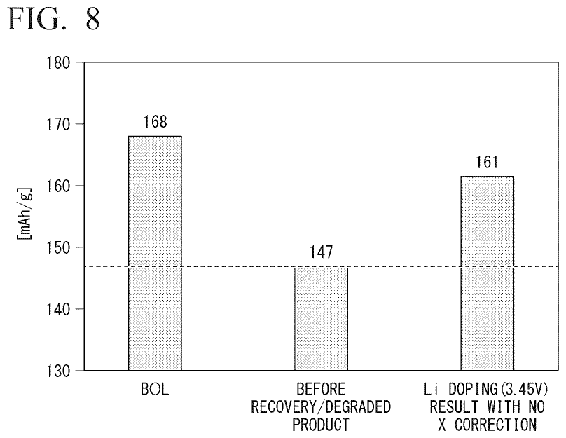

Results obtained by performing pressing and washing in combination and performing a recovery treatment based on the optimal value of the doping amount without consideration of the correction coefficient X are shown in FIG. 8. As is clear from FIG. 8, the recovery rate is approximately 96%, which cannot be said to be sufficient.

In another embodiment of the present invention, provided is a method for recovering performance of a positive electrode for a lithium-ion secondary battery by doping lithium ions into the positive electrode for a lithium-ion secondary battery having a decreased capacity,
in which the doping of the lithium ions is performed in an electrolytic solution by discharge using a lithium electrode as a counter electrode,
the doping of the lithium ions is controlled based on an accumulated value of a current upon conduction of electricity, and
an accumulated value of the current upon completion of the conduction of electricity is set based on a difference between a capacity in the initial state of the lithium-ion secondary battery and a capacity of the lithium-ion secondary battery having a decreased capacity and a correction coefficient.

In this context, the correction coefficient preferably includes at least one of a first correction coefficient based on the difference between the capacity in the initial state of the lithium-ion secondary battery and the capacity of the lithium-ion secondary battery having a decreased capacity, a second correction coefficient based on an amount of lithium ions consumed in a formation step of the lithium-ion secondary battery, and a third correction coefficient based on a discharge efficiency of the lithium-ion secondary battery.

An embodiment of the present invention is described above, but the technical scope of the present invention is not limited to the embodiment, and it is possible to add a variety of changes within the scope of the gist of the present invention. Additionally, it is possible to appropriately substitute a component in the embodiment with a well-known component within the scope of the gist of the present invention.

What is claimed is:

1. A method for recovering performance of a positive electrode for a lithium-ion secondary battery by doping lithium ions into the positive electrode for a lithium-ion secondary battery having a decreased capacity,
wherein the doping of the lithium ions is performed in an electrolytic solution by discharge using a lithium electrode as a counter electrode, and
the discharge is performed within a range of an accumulated discharge amount DG [Ah] represented by formula 1 below:
$$0.95 \times DG 0 \leq DG \leq 1.05 \times DG 0 , \qquad Formula 1$$
wherein DG0 is a value that is calculated by formula 2 below:
$$DB \times [ ( D B - DA ) / DB + X ] , \qquad Formula 2$$
wherein DB [Ah] is a capacity of the lithium-ion secondary battery in an initial state, DA [Ah] is a capacity of the lithium-ion secondary battery having a decreased capacity, and X is a correction coefficient that is set based on at least one of X1, X2, and X3 below:
X1: a correction coefficient based on lithium ions consumed to form a film in a formation step of the lithium-ion secondary battery in an initial state,
X2: a correction coefficient based on degradation of a negative electrode in the lithium-ion secondary battery, and
X3: a correction coefficient based on reaction resistance and migration resistance of lithium ions in the lithium-ion secondary battery.

2. The method according to claim 1, which is performed non-destructively with respect to the positive electrode.

3. The method according to claim 1, wherein the discharge is performed at a constant current.

4. The method according to claim 1, wherein the (DB−DA)/DB is 0.7 or more.

5. The method according to claim 2, wherein the (DB−DA)/DB is 0.7 or more.

6. The method according to claim 3, wherein the (DB−DA)/DB is 0.7 or more.

7. The method according to claim 1, wherein the X1 is a numerical value within a range of 0 to 0.25, the X2 is a numerical value within a range of 0 to 0.1, and the X3 is a numerical value within a range of 0 to 0.18.

8. The method according to claim 1, wherein the X3 is calculated by formula 3 below:
$$X 3 = X 3 a + X 3 b + X 3 c + X 3 d , \qquad Formula 3$$
wherein X3a is a correction coefficient based on reaction resistance and migration resistance of lithium ions in the positive electrode upon using the lithium-ion secondary battery after performance recovery and is a numerical value within a range of 0 to 0.05,
X3b is a correction coefficient based on reaction resistance and migration resistance of lithium ions in the negative electrode upon using the lithium-ion secondary battery after performance recovery and is a numerical value within a range of 0 to 0.05,
X3c is a correction coefficient based on migration resistance of lithium ions in the electrolytic solution upon using the lithium-ion secondary battery after performance recovery and is a numerical value within a range of 0 to 0.04, and
X3d is a correction coefficient based on migration resistance of lithium ions in a separator upon using the lithium-ion secondary battery after performance recovery and is a numerical value within a range of 0 to 0.04.

9. A method for recovering performance of a positive electrode for a lithium-ion secondary battery by doping lithium ions into the positive electrode for a lithium-ion secondary battery having a decreased capacity,
wherein the doping of the lithium ions is performed in an electrolytic solution by discharge using a lithium electrode as a counter electrode,
the doping of the lithium ions is controlled based on an accumulated value of a current upon conduction of electricity, and
an accumulated value of the current upon completion of the conduction of electricity is set based on a difference between a capacity in the initial state of the lithium-ion secondary battery and a capacity of the lithium-ion secondary battery having a decreased capacity, and a correction coefficient.

10. The method according to claim 9, wherein the correction coefficient is set based on at least one of a first correction coefficient based on the difference between the capacity in the initial state of the lithium-ion secondary battery and the capacity of the lithium-ion secondary battery having a decreased capacity, a second correction coefficient based on an amount of lithium ions consumed in a formation step of the lithium-ion secondary battery, and a third correction coefficient based on a discharge efficiency of the lithium-ion secondary battery.
